(19) United States
(12) Patent Application Publication
(10) Pub. No.: US 2026/0194186 A1
(43) Pub. Date: Jul. 9, 2026

(54) Alternative Method for Fabricating Metallic Cylindrical Shell Courses of Large Diameter Pressure Vessels Containing High Internal Pressure and Using Various Methods for Joining the Shell Courses

(71) Applicants: Maan Jawad, Bothell, WA (US); Zhili Feng, Knoxville, TN (US)

(72) Inventors: Maan Jawad, Bothell, WA (US); Zhili Feng, Knoxville, TN (US)

(21) Appl. No.: 19/008,788

(22) Filed: Jan. 3, 2025

Related U.S. Application Data
(60) Provisional application No. 63/693,031, filed on Sep. 10, 2024.

(51) Int. Cl. F17C 1/08

(52) U.S. Cl. CPC F17C 1/08; F17C 2201/0104; F17C 2203/012; F17C 2203/0678; F17C 2209/221; F17C 2223/036; F17C 2260/011

(57) ABSTRACT

The thickness of a metallic cylindrical shell in a pressure vessel subjected to high internal pressure formed from a metallic plate or forging is substantially reduced from the required thickness in order to economically fabricate the cylindrical shell. The remaining required thickness is furnished by a) a multitude of rods formed in circumferential rings placed on the outside of the metallic cylindrical shell and encased in a concrete shell poured on the outside of the metallic shell, and b) high-strength post-tension wires placed on the outside of a concrete shell. Multiple cylindrical shells of this type of construction can be joined to each other to form a long cylinder by using various connection details.

### CROSS-REFERENCE TO RELATED APPLICATIONS

This application claims the benefits of U.S. Provisional Application 63/693,031, filed Sep. 10, 2024 by the present inventors, the disclosure of which is incorporated by reference in its entirety.

### REFERENCES CITED

### U.S. Patent Documents

U.S. Pat. No. 9,562,646 B2 Feb. 7, 2017 Wang, et al.

### BACKGROUND OF THE INVENTION

This invention relates to manufacturing cylindrical shell segments (hereby referred to as cylindrical courses) of large diameter pressure vessels subjected to high internal pressure. The length and other aspects of these cylindrical courses depend on the capacity of the manufacturer regarding such items as forming, welding, assembling, and lifting.

This invention also relates to methods of joining the various cylindrical courses together to form the long cylindrical shell section of a pressure vessel.

The required thickness of a cylindrical shell fabricated from a formed metallic plate or forging increases with an increase in the radius as well as internal pressure. Eventually the required thickness becomes impractical to manufacture for the following reasons:

1. It is extremely difficult to produce very thick metallic plates or forgings with homogeneous properties in the strength required to build a pressure vessel shell.

2. It is extremely difficult to bend and form very thick plates into cylinders.

3. Welding the longitudinal edges of formed thick plates to form a complete cylinder is very difficult, if not impossible, to accomplish.

4. Nondestructive examination of very thick welds by radiographic or ultrasonic examination, which is required by Construction Codes, is extremely difficult, if not impossible, to perform.

This invention avoids the above-mentioned hurdles by reducing the minimum required metallic shell thickness and then adding to the outside surface of the metallic shell a multitude of circumferential rods with small cross sectional area made of steel or composite material (such as CFRP—carbon fiber reinforced polymer) to make up the required total thickness. Reducing the metallic shell thickness makes it readily available, easily formed and welded, and easily inspected by available methodology. Such construction of combining metallic inner shell with circumferential rods encased in concrete reduces the cost substantially and makes construction of large diameter pressure vessels with high internal pressure feasible.

This invention of having the cylindrical shell consist of a metallic cylinder plus circumferential rods is completely different from circular concrete water, or other liquid, storage tanks where the reinforced and/or prestressed concrete shell is the main source of holding the internal hydrostatic pressure caused by the water head and the very thin metallic inner liner is used only as a leakage barrier and not for strength. Also, concrete water storage tanks have negligible longitudinal tensile forces due to hydrostatic water head while pressure vessels have substantial longitudinal tensile forces due to high gaseous internal pressure.

### SUMMARY OF THE INVENTION

This invention consists of
1. manufacturing a pressure vessel with a solid metallic inner shell where the minimum thickness required to resist the internal pressure is substantially reduced.
2. adding a multitude of circumferential rods on the outside surface of the metallic inner shell in order to make up the total thickness required to hold the internal pressure.
3. providing longitudinal rods to support the circumferential rods.
4. encasing the circumferential and longitudinal rods in a concrete shell poured on the outside surface of the metallic shell in order to hold the rods in place. The concrete is needed only as a means of holding the rods in place and transferring the internal pressure forces to the rods.
5. preventing the concrete shell from having high tension stress due to internal pressure by wrapping it on the outside with high-strength post-tension wires.
6. joining multitude of cylindrical courses together to form the long cylindrical shell section of a pressure vessel by using various connection sections at the joint.

These and other features and advantages of the present invention will become apparent from the following description of the invention, when viewed in accordance with the accompanying drawings and the appended claims. Before current embodiments are explained in further detail, it is to be understood that the invention is not limited to the details of fabrication or operation set forth in the following description or illustrated in the drawings. The invention may be implemented in various other embodiments and of being practiced or be carried out in alternative ways not expressly disclosed herein.

### DESCRIPTION OF THE DRAWINGS

In the accompanying drawings which form part of the specification and wherein like numerals and letters refer to like parts wherever they occur

FIG. 1. is a schematic of a pressure vessel with a long cylindrical shell section comprising two cylindrical courses joined together and two end heads in accordance with the present invention.

FIG. 2 is a detail supplementing the reduced thickness of the metallic cylindrical shell with circumferential rings comprising reinforcing rods.

FIG. 3 is a detail of supporting the circumferential reinforcing rods with longitudinal rods.

FIG. 4 is a detail of encapsulating the circumferential rods and longitudinal rods in concrete.

FIG. 5 is a detail of using high-strength post-tension wires to encase the reinforced concrete shell.

FIG. 6 is a detail of the composite shell of a cylindrical course comprising inner metallic shell, circumferential rods, and concrete with applied internal and external pressure.

FIG. 7 is a detail of high-strength post-tension wire with equivalent simulated thickness.

FIG. 8 is a detail of a joint connecting two cylindrical courses together to form a long cylinder. The joint consists essentially of welded inner shells and an outer segmented connecting shell.

FIG. 9 is a detail of a joint connecting two cylindrical courses together to form a long cylinder. The joint consists essentially of welded inner shells and an outer connecting shell consisting of multitude of thin shell segments.

FIG. 10 is a detail of a joint connecting two cylindrical courses to form a long cylinder. The joint consists essentially of an inner connecting shell welded to the two inner shells and an outer segmented connecting shell with a nozzle penetrating the inner shell and the outer connecting shells.

FIG. 11 is a detail of a joint connecting two cylindrical courses to form a long cylinder. The joint consists essentially of an inner connecting shell welded to the two inner shells and an outer multi-layer connecting shell with a nozzle penetrating the inner shell and the outer multi-layer connecting shells.

FIG. 12 is a detail of a joint connecting two cylindrical courses together to form a long cylinder. The joint consists of welded inner shells and outer layers of high-strength post-tension wires.

FIG. 13 is a detail of a joint connecting the inner shell of a cylindrical course comprising an inner shell, circumferential rods, concrete, and high-strength post-tension wires to a second inner shell. Circumferential rods, concrete and high-strength post-tension wires are then attached to the second inner shell to form a longer cylinder.

FIG. 14 is a detail of a joint connecting the inner shell of a cylindrical course comprising an inner shell, circumferential rods, concrete, and high-strength post-tension wires to a second cylinder comprising essentially an inner shell with prestress wires on the outside.

FIG. 15 is a detail of a joint connecting the inner shell of a cylindrical course comprising an inner shell, circumferential rods, concrete, and high-strength post-tension wires to a second cylindrical course comprising a thicker shell.

FIG. 16 is a detail of a joint connecting the inner shell of a cylindrical course comprising an inner shell with prestress wires on the outside to a second cylindrical course comprising an inner shell with prestress wires on the outside.

### DETAILED DESCRIPTION OF THE CURRENT EMBODIMENTS

The typical metallic pressure vessel (prior art) subjected to internal pressure consists of a solid metallic cylindrical shell and heads at each end of the cylinder. The thickness of the said solid metallic cylindrical shell is normally obtained from the classical equation

$$t = {R}_{i} \{ {[ ( {S}_{s} + {P}_{i} ) / ( {S}_{s} - {P}_{i} ) ]}^{0.5} - 1 \} \qquad ( 1 )$$

where, Pᵢ is internal pressure, Rᵢ is the inside radius of the cylindrical shell, Sₛ is the allowable stress of the shell material, and t is the theoretical required metallic cylindrical shell thickness.

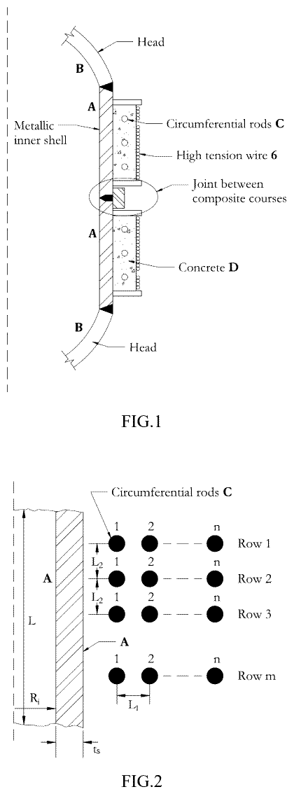

In the current embodiment of invention, a pressure vessel, FIG. 1, subjected to internal pressure has solid metallic cylindrical inner shells A (the inner shells hereafter) with rods C placed circumferentially on the outside of the inner shells. The rods are encased in concrete D with high-strength post-tension wires 6 on the outside of the concrete. The inner shell A, rods C and encasing concrete D, high-strength post-tension wires 6 and other auxiliary components illustrated in FIG. 1 form a composite cylindrical course. The two composite cylindrical courses are joined together by welding the inner shells A and addition of an outer connecting shell, FIG. 1, by various methods to form the long cylindrical shell section of a pressure vessel. Heads B are welded to the ends of the long cylindrical shell section to form a complete pressure vessel. The heads can be of any shape such as hemispherical, ellipsoidal, torispherical, conical, or flat.

Compared to the typical prior art metallic pressure vessel, the thickness of the inner shell A in this invention is reduced substantially to a value of tₛ and a multitude of circumferential rings made of steel rods or composite rods C (FIG. 2) are added to the outside surface of the inner shell to make up the total thickness required by Eq. (1). These circumferential rods C are shown in FIG. 2 as 1, 2, . . . n.

The amount of reduction in the thickness of the inner shell A is based on availability of metallic material and fabrication capability of the manufacturer. However, the reduced thickness, tₛ, of the inner shell A cannot be below that given by Eq. (2) to assure transfer of longitudinal forces between the top and bottom heads.

$${t}_{s} \geq {R}_{i} \{ {[ ( {S}_{s} + {P}_{i} ) / {S}_{s} ]}^{0.5} - 1 \} \qquad ( 2 )$$

Circumferential rods 1, 2, . . . n in FIG. 2 have a diameter d and are normally spaced radially by distance L₁ and longitudinally by distance L₂. Distances L₁ and L₂ are normally taken as

$${L}_{1} \geq 2 d . \qquad ( 3 )$$

$${L}_{2} \geq 2 d . \qquad ( 4 )$$

The total required cross-section area, A_{T}, of the circumferential rods in any given row, such as in Row 1, Row 2, . . . Row m, (FIG. 2) may be determined by Eq. (5)

$${A}_{T} = ( {S}_{s} / {S}_{r} ) ( t - {t}_{s} ) ( {L}_{2} ) \qquad ( 5 )$$

where, Sᵣ is the allowable stress of the circumferential rods.

In FIG. 2, the area of the inner shell A over the length L plus all of the areas of the circumferential rods in all of the rows may be determined by Eq. (6)

$$( L ) ( {t}_{s} ) + ( {A}_{r} ) ( n ) ( m ) = ( {P}_{i} ) ( {R}_{i} ) ( L ) / {S}_{s} \qquad ( 6 )$$

where, L is the overall length of the inner shell, Aᵣ is the area of one rod, n is the total number of rods in a given row and m is the total number of rows in the longitudinal direction of the cylindrical shell over the length L.

Hence, for example, if a pressure vessel has an inside radius Rᵢ=60 inches, length of inner shell L=120 inches, internal pressure Pᵢ=1200 psi, allowable stress of metallic shell Sₛ=28,000 psi, then for a regular pressure vessel the theoretical required thickness of the metallic cylindrical shell per Eq. (1) is t=2.63 inches. It is assumed for this example the 2.63-inch thick plate for the cylindrical shell is not readily available but a 1.50-inch plate is available to use as the inner shell. Hence, tₛ=1.50 inch and the remaining 1.13-inch thickness will be furnished by the use of circumferential rods, in order to hold the inner pressure, Pᵢ. The 1.5-inch inner shell thickness is greater than the minimum thickness of 1.25 inch obtained from Eq. (2), hence it is adequate to use.

Let the allowable rod stress Sᵣ=30,000 psi, diameter of individual rod d=1.0 inch with a cross sectional area of Aᵣ=0.785 inch², and longitudinal distance between rods from Eq. (4) L₂=2.0 inch. Hence, from Eq. (5) the required total rod area in any given row is A_{T}=2.11 inch². Dividing A_{T} by Aᵣ gives the number of rods needed per row n=2.7 which must be rounded up to n=3 rods per row. The minimum total number of rows of the circumferential rods required along the full length L of the inner shell A in FIG. 2 is obtained from Eq. (6) as m=55 rows. The actual longitudinal spacing of the circumferential rods along the 120 inch long shell is L₂=2.2 inches. This spacing satisfies the requirement of Eq. (4).

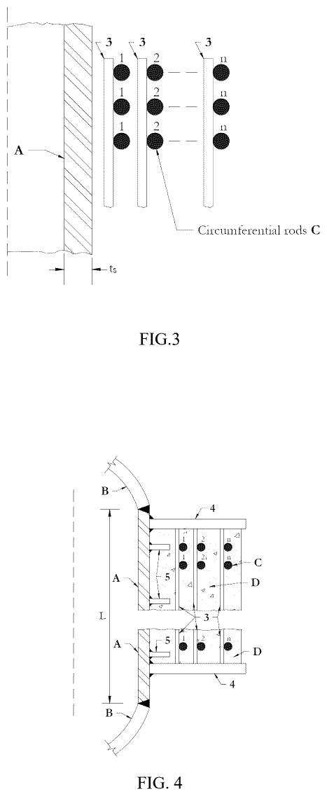

In this invention the circumferential rods C are held in place by longitudinal steel or composite rods 3 (FIG. 3). The longitudinal rods 3 are spaced approximately four feet apart around the circumference of the vessel (with a minimum of four longitudinal rods). The diameter of the longitudinal rods is normally taken as ½ inch.

The circumferential and longitudinal rods are encased in a concrete shell D (FIG. 4). The concrete shell serves as an encasement for the circumferential and longitudinal rods and also as a medium for transferring the loads due to internal pressure to the circumferential rods.

Two circumferential metallic ring plates 4 (FIG. 4) are welded to the outside of the inner shell A near the top and bottom of the inner shell. Their purpose is to act as supports for the concrete slurry when it is poured on the outside of the inner shell and also to act as a support of the solid concrete shell after it is cured. The thickness of each ring plate is about 1.0 inches and the width is the same as, or slightly greater than, the thickness of the concrete shell D.

The concrete outer shell D is also kept in contact with the inner shell A by using round welded headed studs 5 (FIG. 4) attached or welded to the outside of the inner shell prior to pouring of the concrete. The round headed studs are approximately two inches long and one-half inch in diameter. They are spaced at approximately two feet apart circumferentially and longitudinally.

When the pressure vessel is subjected to internal pressure, tensile stress occurs in the concrete shell D. The tensile stress in the concrete during operation must be kept below the rupture modulus, fᵣ specified by various international standards such as the American Concrete Institute ACI-318 Standard. The tensile limit can be approximated by the expression

$${f}_{r} = ( 125.75 + 0.133 {f}_{c}^{′} ) / ( 1 + 0.0000 \; 964 {f}_{c}^{′} ) \qquad ( 7 )$$

where, f′_{c} is the compressive strength of concrete and fᵣ is the rupture modulus of the concrete. The allowable tensile stress, fₜ, is taken as

$${f}_{t} = 0.65 {f}_{r} / FS \qquad ( 8 )$$

where, FS is factor of safety. Hence, for example, a concrete with 4000 psi compressive strength using a factor of safety of 1.5 results in an allowable tensile stress of 205 psi.

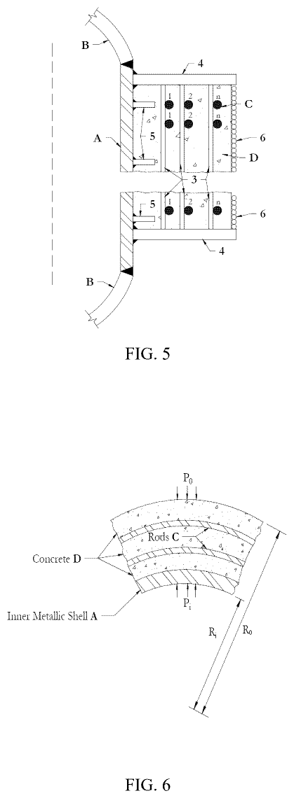

The tensile stress in the concrete D during operation of the pressure vessel may potentially exceed the allowable tensile stress given by Eq. (8). In another embodiment of the invention, high-strength post-tension wires 6 (FIG. 5) are wrapped around the outside of the concrete shell D, to control the tensile stress in the concrete. The applied high tension force in the wire puts the concrete under compression such that the total stress in concrete D due to tension from the internal pressure Pᵢ plus the external compression pressure from the high-strength post-tension wire Pₒ is below the allowable stress value obtained from Eq. (8).

The amount of tension force in the high-strength post-tension wires needed to keep the tensile stress in the concrete during operation below that given by Eq. (8) is obtained by trial-and-error. The procedure consists of first assuming a value of external pressure Pₒ (FIG. 6). Calculations are then made using standard Strength of Materials equations to determine the stress in the inner shell A, concrete shell D, and circumferential rods C (FIG. 6) due to given internal pressure Pᵢ and the assumed external pressure Pₒ. If the calculated tensile stress in the concrete is higher than that allowed by Eq. (8), a new higher Pₒ is assumed in order to increase the compressive stress in the concrete. This process is repeated until the calculated tensile stress in the concrete due to internal and external pressures is acceptable. This largest value of Pₒ is then used to determine the needed tension force in the high-strength post-tension wires. The tension force required to pre-stress the wires during wire winding operation can be substantial, in order to keep the concrete stress below the allowable during operation.

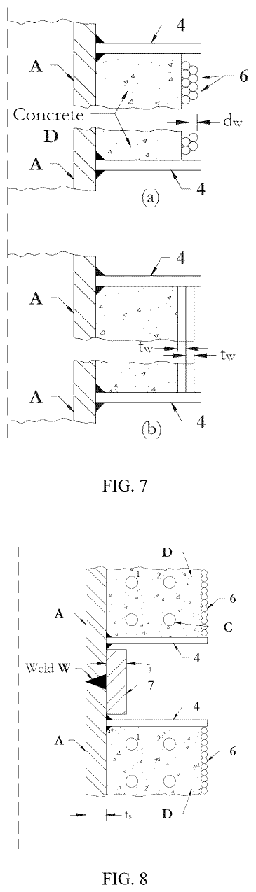

In order to calculate the diameter of the high-strength post-tension wire and the number of layers required, the high-strength post-tension wire in sketch a of FIG. 7 is assumed smeared over the length of the cylinder as shown in sketch b of FIG. 7. The equivalent thickness of the smeared high-strength post-tension wires is

$${t}_{w} = π {d}_{w} / 4 \qquad ( 9 )$$

where, t_{w} is the equivalent thickness of high-strength post-tension wire and d_{w} is the diameter of the high-strength post-tension wire.

The number of layers and equivalent thickness of the high-strength post-tension wire is obtained from the equation

$$( q {t}_{w} ) = {P}_{o} {R}_{o} / {S}_{w} \qquad ( 10 )$$

Where, S_{w} is the allowable stress of high-strength post-tension wire, q is the number of layers of high-strength post-tension wire.

Once the diameter of the wire and the number of wire layers are known then the high-strength post-tension wire may be used as part of the total required thickness needed to resist the internal pressure in the vessel.

Cases arise where many composite cylindrical courses need to be joined together to form the long cylindrical shell section of a pressure vessel prior to attaching the top and bottom heads. A connecting section or joint is used to join two shell courses together. The details of the connecting joint between any two cylindrical courses are shown in FIGS. 8 through 16. In FIG. 8 the inner shells A of two cylindrical courses are first welded together by weld W and then an outer connecting cylindrical shell 7 made of segments is placed on the outside surface of the inner shell and welded to form a complete cylinder. The total thickness of inner shell A and outer connecting shell 7 must be equal or greater than that given by Eq. (1).

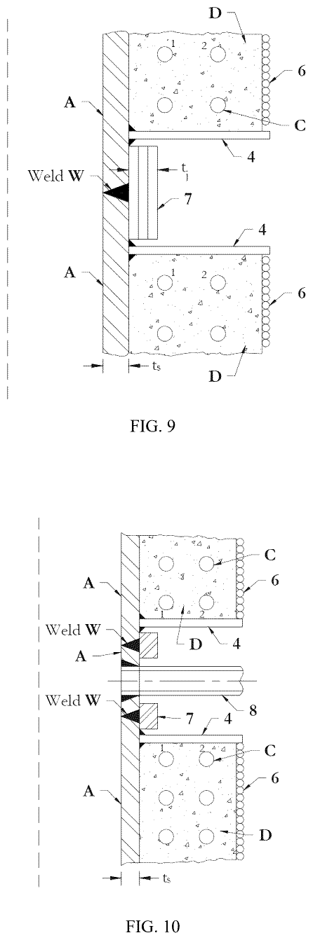

FIG. 9 is the same as FIG. 8 except the outer connecting shell 7 at the joint is made of thin plates welded together to form a cylinder. This construction is preferable if the outer connecting shell 7 is too thick to form and weld from a single plate.

Nozzles may be inserted to the inner shell A at the joint as shown in FIG. 10. The nozzle neck 8 penetrates the inner shell A and the outer connecting shell 7 as shown in FIG. 10.

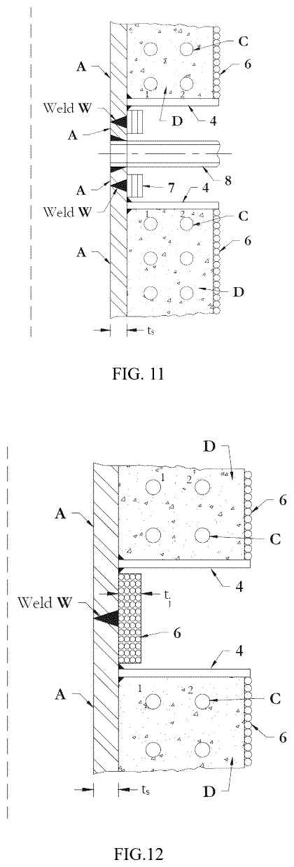

FIG. 11 shows the same detail as in FIG. 10 with the outer connecting shell 7 made of multitude of thin plates to facilitate fabrication.

High-strength post-tension wires 6 may be used in lieu of solid outer shell plate 7 at the joint as shown in FIG. 12. The choice of using a wire at the joint depends on such factors as the length and diameter of the cylindrical courses as well as the total weight of the courses.

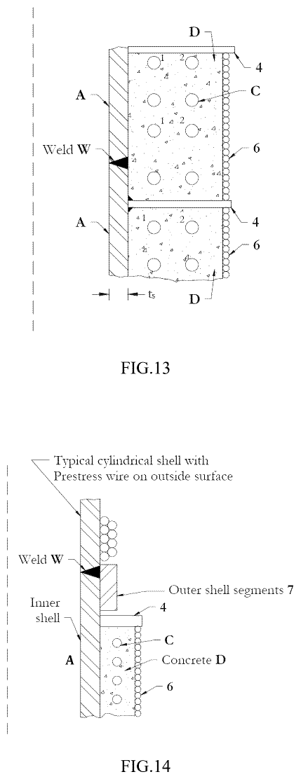

An alternative method to connect many cylindrical courses together to form the long cylindrical shell of a pressure vessel prior to attaching them to the top and bottom heads is shown in FIG. 13. This detail eliminates the need for one of the circular ring plates 4 at the end of the cylindrical course.

Attaching the cylindrical course described in this invention to a metallic cylindrical shell with prestress wires on the outside is illustrated in FIG. 14.

Attaching the cylindrical course described in this invention to a thick metallic cylindrical shell is illustrated in FIG. 15.

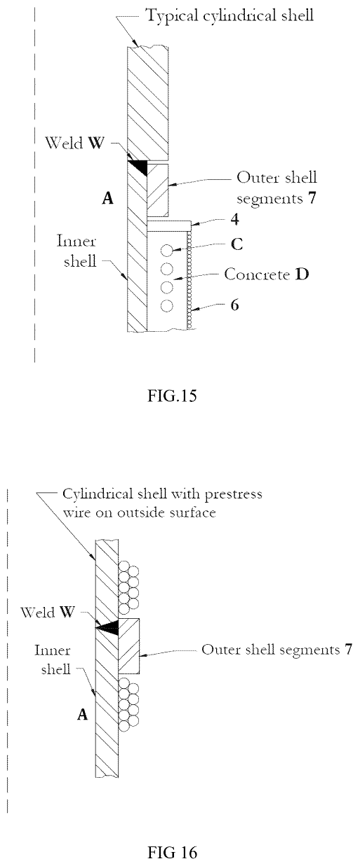

FIG. 16 illustrates two cylindrical courses each comprising a metallic inner shell with prestress wires on the outside of the inner shell joined together using the various connection methods described in this invention.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognizes an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims.

What is claimed is:

1. A cylindrical course in a pressure vessel subjected to high internal pressure, comprising:
(a) an inner shell made of solid metallic plate or forging whose thickness is reduced substantially from the minimum required to hold the internal pressure;
(b) a multitude of circumferential rods placed outside of said inner shell with predetermined spacing among said circumferential rods and said inner shell;
(c) a multitude of longitudinal rods securing said circumferential rods in place; and
(d) a concrete shell encasing said circumferential rods and said longitudinal rods outside of said inner shell and further serving as a medium to transfer a substantial portion of load caused by the internal pressure from said inner shell to said circumferential rods.

2. The cylindrical course in claim 1, wherein the thickness of said inner shell is substantially adequate to resist the total longitudinal forces in the vessel due to internal pressure.

3. The cylindrical course in claim 1, wherein said circumferential rods are fabricated in a concentric pattern.

4. The cylindrical course in claim 1, wherein said circumferential rods are fabricated in spiral pattern.

5. The cylindrical course in claim 1, further comprising metallic ring plates at each end of said concrete shell and multitude of headed stud anchor rods welded to the outside surface of the said inner shell, thereby containing said concrete shell in place.

6. The cylindrical course in claim 1, further comprising high-strength post-tension wires wrapped on the outside surface of said concrete shell, thereby keeping the tensile stress in said concrete shell due to internal pressure below the allowable tensile stress.

7. The cylindrical course in claim 6, wherein the total area of said inner shell plus said circumferential rods plus said high-strength post-tension wires are sufficiently adequate to resist the total internal pressure in a safe manner.

8. The cylindrical course in claim 6, wherein said high-strength post-tension wires are applied in multitude of layers.

9. A method of connecting a first cylindrical course to a second cylindrical course, thereby forming the long cylindrical shell section in a pressure vessel subjected to high internal pressure, the method comprising:
(a) providing a first cylindrical course having a first metallic inner shell and a first outer shell such that the total thickness of said first inner shell plus said outer shell is adequate to resist the internal pressure in the pressure vessel;
(b) providing a second cylindrical course having a second metallic inner shell and an optional second outer shell such that the total thickness of said second inner shell plus said optional second outer shell is sufficiently adequate to resist the internal pressure in the pressure vessel;
(c) connecting by welding at the joint between said first metallic inner shell of said first cylindrical course and said second metallic inner shell of said second cylindrical course, thereby forming a welded inner shell region at said joint; and
(d) placing over said welded inner shell region an outer connecting shell made of cylindrical metallic segments and weld said outer connecting shell to said welded inner shell such that the total thickness of said welded inner shell plus said outer connecting shell is sufficiently adequate to resist the internal pressure in the pressure vessel.

10. The method of claim 9 wherein said outer connecting shell is made from a multitude of thin layers of cylindrical metallic segments welded on the outside surface of said welded inner shell such that the total thickness of said welded inner shells plus said layered outer connecting shell is sufficiently adequate to resist the internal pressure in the pressure vessel.

11. The method of claim 9 wherein said outer connecting shell is made from high-strength post-tension wire and wrapped in a plurality of layers on the outside surface of said welded inner shell such that the total thickness of said welded inner shell plus said high-strength post-tension wire is sufficiently adequate to resist the internal pressure in the pressure vessel.

12. The method of claim 9 wherein either said first cylindrical course or said second cylindrical course is provided in accordance with claims 1 through 8.

13. The method of claim 9 wherein said first outer shell and said second outer shell are prestress high-strength post-tension wires wrapped in a plurality of layers on the outside surface of the corresponding inner shell such that the total thickness of said inner shell plus said high-strength post-tension wires is adequate to resist the internal pressure in the pressure vessel.

14. The method of claim 9 wherein said first outer shell is prestress high-strength post-tension wires wrapped in a plurality of layers on the outside surface of said first inner shell such that the total thickness of said inner shell plus said high-strength post-tension wires is sufficiently adequate to resist the internal pressure in the pressure vessel.

15. The method of claim 9 wherein said second cylindrical course does not have said optional second outer shell and the thickness of said second inner shell is adequate to resist the internal pressure in the pressure vessel.

16. The method of claim 9 wherein a nozzle penetrates through said outer connecting shell and said welded inner shell.

17. The method of claim 10 wherein a nozzle penetrates through said layered outer connecting shell and said welded inner shell.

18. A method of connecting a first cylindrical course to a second cylindrical course, thereby forming the long cylindrical shell section in a pressure vessel subjected to high internal pressure, the method comprising:
(a) providing the first cylindrical course having the first metallic inner shell and first outer shell such that the total thickness of said first inner shell plus said outer shell is sufficiently adequate to resist the internal pressure in the pressure vessel;
(b) providing the second cylindrical course having the second metallic inner shell;
(c) connecting by welding at the joint between said first metallic inner shell of said first cylindrical course and said second metallic inner shell of said second cylindrical course, thereby forming a welded inner shell; and
(d) adding a second outer shell on the outside surface of said second inner shell to complete said second cylindrical course such that the total thickness of said second inner shell plus said second outer shell is sufficiently adequate to resist the internal pressure in the pressure vessel.

19. This invention is applicable to pressure vessels used in high internal pressure fluids in the petrochemical industry, fossil and nuclear power generation industry, as well as in high internal pressure fluid storage facilities in various industries.
